(19) United States
(12) Patent Application Publication
(10) Pub. No.: US 2015/0132525 A1
(43) Pub. Date: May 14, 2015

(54) METHOD FOR MANUFACTURING SMALL-SIZED SHEET, STRUCTURAL ELEMENT, AND METHOD FOR MANUFACTURING STRUCTURAL ELEMENT

(71) Applicant: ASAHI GLASS COMPANY, LIMITED, Chiyoda-ku (JP)

(72) Inventors: Yasumasa KATO, Tokyo (JP); Takahiro Nagata, Tokyo (JP); Isao Saito, Tokyo (JP); Akio Koike, Tokyo (JP); Kenji Kitaoka, Tokyo (JP); June Sasai, Tokyo (JP)

(73) Assignee: ASAHI GLASS COMPANY, LIMITED, Chiyoda-ku (JP)

(21) Appl. No.: 14/594,488

(22) Filed: Jan. 12, 2015

Related U.S. Application Data
(63) Continuation of application No. PCT/JP2013/069019, filed on Jul. 11, 2013.

(30) Foreign Application Priority Data
Jul. 11, 2012 (JP) 2012-155565

(51) Int. Cl. C03B 33/09; C03B 27/04; B32B 17/06

(52) U.S. Cl. CPC C03B 33/091; B32B 17/06; C03B 27/0413; B32B 2250/03
USPC 428/45; 65/112

(57) ABSTRACT

The present invention provides a method for manufacturing a small-sized physically-strengthened glass sheet having excellent design properties, a structure using the small-sized physically-strengthened glass sheet, and a method for manufacturing the structure. In the cutting step in the method for manufacturing a physically-strengthened glass sheet of the present invention, the intermediate layer 17 is locally heated at a temperature not higher than the annealing point thereof with a laser beam 20 to thereby locally generate a tensile stress smaller than the internal residual tensile stress CT or a compressive stress in the intermediate layer 17 to control the propagation speed of the crack 30 due to the internal residual tensile stress.

### TECHNICAL FIELD

The present invention relates to a method for manufacturing a small-sized sheet of a small-sized physically-strengthened glass sheet, a structure using the small-sized sheet, a method for manufacturing the structure.

### BACKGROUND ART

As a strengthening method for strengthening glass, there is known a physically strengthening method such as a thermal-tempering-by-air-jets method or the like (for example, see Patent Document 1). A physically-strengthened glass sheet is one produced by strengthening a front surface and a back surface of a glass sheet, in which the front surface and the back surface of the glass sheet are given a residual compressive stress and the inside of the glass sheet is given a residual tensile stress.

Heretofore, since it is difficult to cut a physically-strengthened glass sheet, for manufacturing physically-strengthened glass sheet products, glass sheets are first cut to have a product size and then subjected to physical strengthening treatment according to the thermal-tempering-by-air-jets method or the like.

### BACKGROUND ART DOCUMENT

### Patent Document

Patent Document 1: JP-A-2000-290030

### SUMMARY OF THE INVENTION

### Problems that the Invention is to Solve

As the thermal-tempering-by-air-jets method, there is known a method that comprises heating the glass sheet having a desired product shape up to around the softening point thereof while conveying it with rollers and then spraying cooling air as a coolant to a front surface and a back surface of the glass sheet. For cooling the back surface of the glass sheet according to the method, air is sprayed thereto via a nozzle arranged between rollers, and therefore the rollers require a distance therebetween. Consequently, in a case where the product size is small, there may be a problem in that a forefront in the travel direction of the glass sheet would be brought into contact with a roller or the glass sheet would drop off between the rollers, and therefore the physically-strengthened glass sheet products that can be physically strengthened through roller conveyance are limited to large-sized ones.

There is also known a method where the glass sheet having the desired product shape is hung while held by a jig and a thus-hung glass sheet is strengthened by heating according to the thermal-tempering-by-air-jets method. In this case, small-sized glass sheets can also be strengthened, but an impression of the jig used for holding the glass sheet during the treatment would remain on the physically-strengthened glass sheet, and is therefore unfavorable in point of the design appearance thereof.

From the above, heretofore, it has been difficult to provide a small-sized physically-strengthened glass sheet having excellent design properties. In addition, it has also been difficult to use the physically-strengthened glass sheet in a structure that comprises a plurality of such small-sized glass sheets as combined therein.

The present invention has been made in consideration of the above-mentioned problems, and an object thereof is to provide a method for manufacturing a small-sized sheet that comprises a small-sized physically-strengthened glass sheet having excellent design properties, a structure using the small-sized sheet, and a method for manufacturing the structure.

### Means for Solving the Problems

In order to solve the above-mentioned problem, a method for manufacturing a small-sized sheet according to one embodiment of the present invention comprises:

a strengthening step of physically strengthening a glass sheet by quenching a heated glass sheet with bringing a front surface and a back surface of the heated glass sheet into contact with a coolant, thereby producing a physically-strengthened glass sheet which has a front surface layer and a back surface layer as strengthened layers having a residual compressive stress, and an intermediate layer having an internal residual tensile stress and is formed between the front surface layer and the back surface layer; and

a cutting step of cutting out the small-sized sheet from the physically-strengthened glass sheet by locally irradiating the physically-strengthened glass sheet with a laser beam, moving a laser beam irradiation position on the physically-strengthened glass sheet along a designed cut line, and propagating a crack running through the physically-strengthened glass sheet in a sheet thickness direction,

wherein, in the cutting step, the intermediate layer is locally heated with the laser beam at a temperature not higher than an annealing point thereof to thereby locally generate a tensile stress smaller than the internal residual tensile stress or a compressive stress in the intermediate layer to control a propagation speed of the crack due to the internal residual tensile stress.

Additionally, a method for manufacturing a structure using the small-sized sheet according to one embodiment of the present invention is:

a method for manufacturing a structure comprising an assembly step of framing a plurality of the small-sized sheets obtained by the method for manufacturing the small-sized sheet described above into a frame body to thereby assemble one structure from the plurality of the small-sized sheets.

A structure using the small-sized sheet according to one embodiment of the present invention comprises:

a plurality of small-sized sheets cut out from a physically-strengthened glass sheet which has a front surface layer and a back surface layer as strengthened layers having a residual compressive stress, and an intermediate layer having an internal residual tensile stress and is formed between the front surface layer and the back surface layer; and

a frame body so formed as to be able to frame the small-sized sheets therein,

wherein the plurality of small-sized sheets are framed and fixed in the frame body.

### Advantage of the Invention

According to the present invention, there are provided a method for manufacturing a small-sized physically-strengthened glass sheet having excellent design properties, and a structure using the small-sized physically-strengthened glass sheet.

### BRIEF DESCRIPTION OF THE DRAWINGS

FIG. 1 is a cross-sectional view showing one example of a physically-strengthened glass sheet.

FIG. 2 is a schematic view showing one example of a residual stress distribution in a physically-strengthened glass sheet produced according to a thermal-tempering-by-air-jets method.

FIG. 3 is an explanatory view of a cutting step in the first embodiment of the present invention.

FIG. 4 is a view showing one example of a relationship between the laser beam irradiation position on a physically-strengthened glass sheet and the front edge position of a crack thereof.

FIG. 5 is a schematic view showing one example of a stress distribution on the cross section cut along the A-A line in FIG. 4.

FIG. 6 is a schematic view showing one example of a stress distribution on the cross section cut along the B-B line in FIG. 4.

FIGS. 7A and 7B each show a cross-sectional view of an example of a structure.

FIG. 8 includes views showing one example of a step of cutting out small-sized sheets from a large-sized physically-strengthened glass sheet to form a structure.

FIG. 9 is an explanatory view of a cutting step according to the second embodiment of the present invention.

### MODE FOR CARRYING OUT THE INVENTION

Embodiments of carrying out the present invention are described below with reference to the drawings. In each drawing, the same or corresponding reference sign is given to the same or corresponding constitution to omit further description thereof. In the following embodiments, the small size of a small-sized sheet is meant to indicate such a small size of a glass sheet that it is difficult to convey with conveyor rollers in cooling the back surface of the sheet.

### First Embodiment

The small-sized sheet is the small-sized physically-strengthened glass sheet cut out from a large-sized physically-strengthened glass sheet. The structure comprises the plurality of small-sized sheets of the physically-strengthened glass sheet, and the frame body so formed as to be able to frame the plurality of small-sized sheets therein. The method for manufacturing the small-sized sheet comprises a strengthening step and a cutting step in this order, and the method for manufacturing the structure comprises an assembly step. The respective steps are described below.

The strengthening step comprises physically strengthening the glass sheet by quenching a heated glass sheet with bringing the front surface and the back surface of the heated glass sheet into contact with a coolant, thereby generating the residual compressive stress in the front surface and the back surface of the glass sheet to strengthen the front surface and the back surface of the glass sheet to produce the physically-strengthened glass sheet. A typical physically-strengthening method is the thermal-tempering-by-air-jets method that comprises spraying the cooling air to the heated glass sheet.

According to the thermal-tempering-by-air-jets method, both sides of the glass sheet having a temperature around the softening point thereof is quenched to thereby provide a temperature difference between the front surface as well as the back surface of the glass sheet and the inside of the glass sheet to generate the residual compressive stress in the front surface and the back surface so as to strengthen the front surface and the back surface of the glass sheet. Such the physically-strengthening method as the thermal-tempering-by-air-jets method or the like is preferred as excellent in productivity, since the time taken for the strengthening treatment is from a few seconds to several tens of seconds.

Not specifically defined, the type of glass of the glass sheet includes, for example, soda lime glass and alkali-free glass. A thickness of the glass sheet may be suitably set depending on the intended use of the glass sheet, and is, for example, from 1.5 to 25 mm. When the thickness thereof is 1.5 mm or more, it is easy to provide a temperature difference between the front surface as well as the back surface of the glass sheet and the inside thereof in the strengthening step, and therefore, such a thickness is preferred.

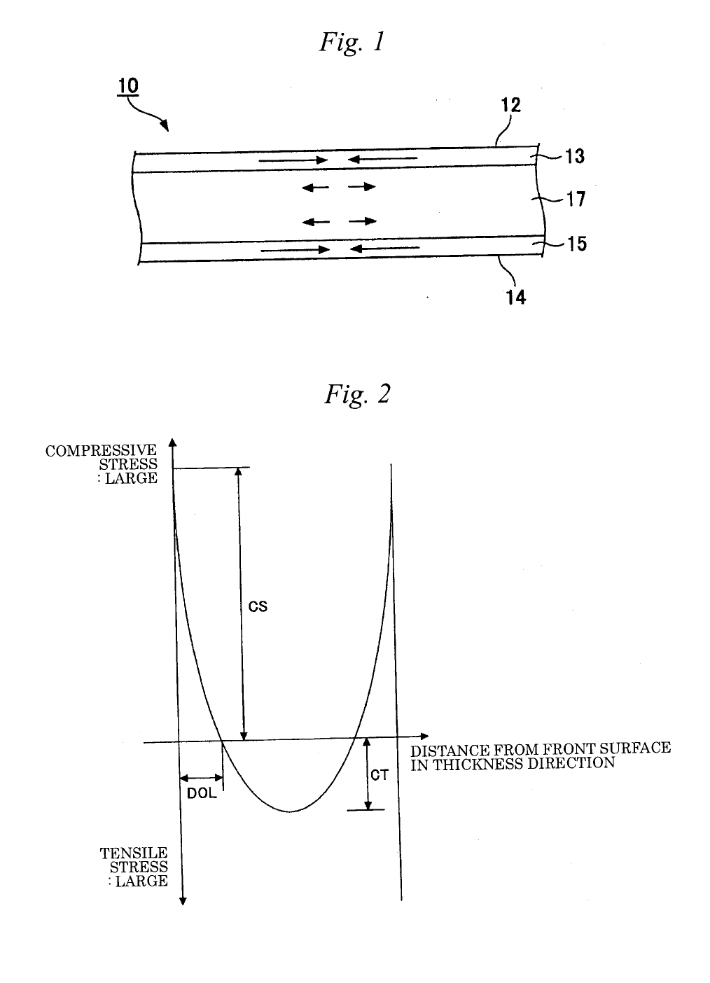

FIG. 1 is a view showing one example of a cross section of a large-sized physically-strengthened glass sheet to be processed in the cutting step in the first embodiment of the present invention. In FIG. 1, an arrowed direction indicates an action direction of a residual stress in the physically-strengthened glass sheet; and a dimension of the arrow indicates an intensity of the residual stress in the physically-strengthened glass sheet.

The physically-strengthened glass sheet 10 includes a front surface layer 13 and a back surface layer 15 as strengthened layers having the residual compressive stress, and an intermediate layer 17 having the residual tensile stress and is formed between the front surface layer 13 and the back surface layer 15.

An edge face of the physically-strengthened glass sheet 10 may be covered with the strengthened layers extending from the edge of the front surface layer 13 and the edge of the back surface layer 15. The edge face of the physically-strengthened glass sheet 10 may not be covered with any strengthened layer, and the edge face of the intermediate layer 17 may be exposed out of the edge face of the physically-strengthened glass sheet 10.

FIG. 2 is a schematic view showing one example of a residual stress distribution in a physically-strengthened glass sheet produced according to a thermal-tempering-by-air-jets method. As shown in FIG. 2, the residual compressive stress decreases in the thickness direction from both surface of the physically-strengthened glass sheet 10 toward the inside thereof, and in the inside of the physically-strengthened glass sheet 10, there has occurred a residual tensile stress. In FIG. 2, CS represents the maximum residual compressive stress (surface compressive stress) (>0) in the strengthened layers 13 and 15, CT represents the internal residual tensile stress (>0) in the intermediate layer 17, and DOL represents the thickness of the strengthened layers 13 and 15. CS, CT and DOL can be controlled by conditions of the physically-strengthening treatment (in the case of the thermal-tempering-by-air-jets method, a heating temperature and a cooling speed of the glass sheet).

The surface compressive stress (CS) of the strengthened layers 13 and 15 and the thickness (DOL) of the strengthened layers 13 and 15 can be measured, for example, with a surface stress meter FSM-6000 (by Orihara Manufacturing). The internal residual tensile stress (CT) of the intermediate layer 17 can be calculated according to the following mathematical expression (1):

CT=CS/a (1)

In the mathematical expression (1), “a” represents a constant to be determined by the temperature of the glass sheet at a start of cooling, the cooling speed of the glass sheet, the thickness of the glass sheet and the like, and is generally within a range of from 2.0 to 2.5.

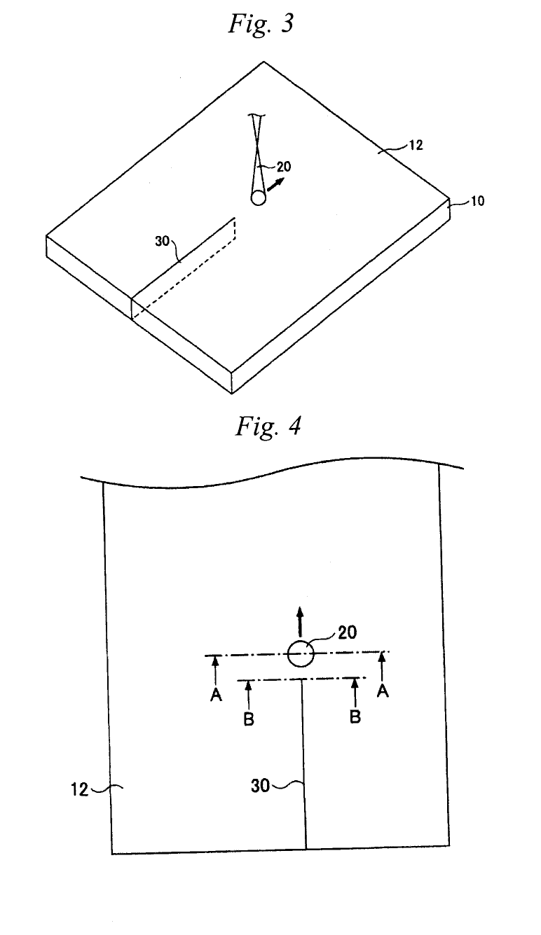

FIG. 3 is an explanatory view of the cutting step in the first embodiment of the present invention. FIG. 4 is a view showing one example of a relationship between the laser beam irradiation position on a large-sized physically-strengthened glass sheet and a front edge position of a crack thereof.

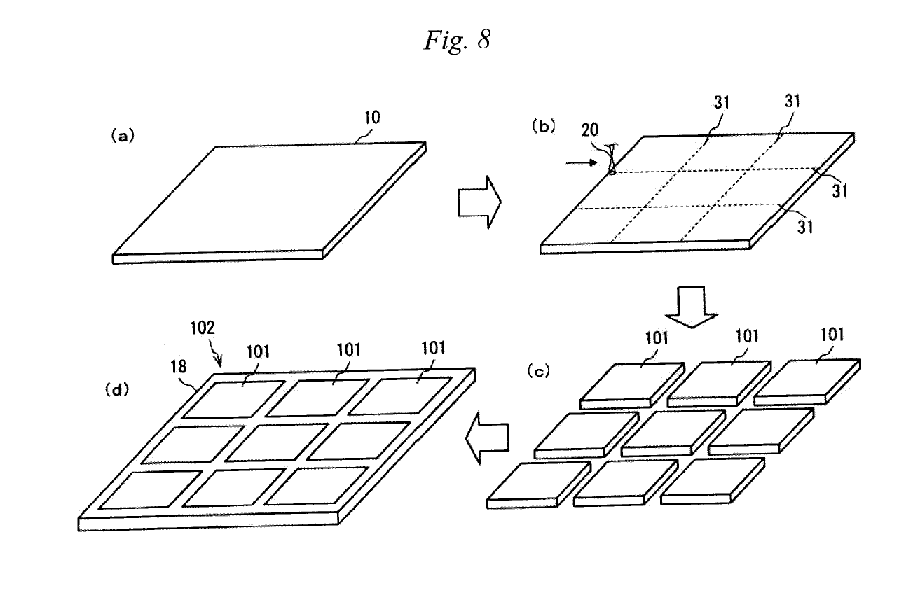

In the cutting step, small-sized sheets 101 (see FIG. 8) are cut out from a large-sized physically-strengthened glass sheet 10. In the cutting step, the irradiation position of the laser beam 20 on the large-sized physically-strengthened glass sheet 10 is moved, and the crack 30 running through the physically-strengthened glass sheet 10 in the thickness direction thereof is thereby propagated. Along the orbit of the irradiation position of the laser beam 20 on the physically-strengthened glass sheet 10, the crack 30 propagates. For moving the irradiation position of the laser beam 20 on the physically-strengthened glass sheet 10, the physically-strengthened glass sheet 10 may be moved, or a source of the laser beam 20 may be moved, or both the two may be moved. In place of moving the physically-strengthened glass sheet 10, the physically-strengthened glass sheet 10 may be rotated. For moving the irradiation position of the laser beam 20 on the physically-strengthened glass sheet 10, a galvano mirror that reflects the laser beam from the source thereof toward the physically-strengthened glass sheet 10 may be rotated.

The crack 30 runs through the physically-strengthened glass sheet 10 in the thickness direction thereof, and the cutting in this embodiment is so-called full-cutting.

A scribe line (marking-off line) may not be formed at the cutting position of the physically-strengthened glass sheet 10 before laser irradiation. A scribe line may be formed, but forming a scribe line takes a lot of trouble. In addition, in forming a scribe line, the physically-strengthened glass sheet 10 may chip off.

At a cutting start position of the physically-strengthened glass sheet 10, an initial crack may be formed. The initial crack may be formed, for example, with a cutter, a file or a laser. In case where the edge faces of the physically-strengthened glass sheet 10 have been ground with a grinding stone or the like, microcracks formed by grinding may be utilized as the initial cracks.

The cutting start position and a cutting end position of the physically-strengthened glass sheet 10 may be on the outer periphery of the physically-strengthened glass sheet 10 or inside the physically-strengthened glass sheet 10. A shape of the cutting line of the physically-strengthened glass sheet 10 may range widely.

After going out from the source of the laser beam 20, the laser beam 20 is focused by an optical system such as a collective lens or the like, then falls on the front surface 12 of the physically-strengthened glass sheet 10, and goes out through the back surface 14 of the physically-strengthened glass sheet 10.

When an intensity of the laser beam 20 at the front surface 12 of the physically-strengthened glass sheet 10 is represented by I₀, and when an intensity of the laser beam 20 after having moved in the physically-strengthened glass sheet 10 by a distance L (cm) is represented by I, then an expression of I=I₀× exp(−α×L) is satisfied. This expression is called the Lambert-Beer law. α represents an absorption coefficient (cm⁻¹) of the physically-strengthened glass sheet 10 relative to the laser beam 20, and is determined by a wavelength of the laser beam 20, a chemical composition of the physically-strengthened glass sheet 10, etc. α may be measured with a UV-visible light-near IR spectrophotometer, etc.

While the laser beam 20 passes through the physically-strengthened glass sheet 10, the physically-strengthened glass sheet 10 absorbs a part of an irradiation energy of the laser beam 20 as heat, and a thermal stress is thereby generated in the physically-strengthened glass sheet 10. Using the thermal stress, cutting of the physically-strengthened glass sheet 10 is controlled.

Cutting of the physically-strengthened glass sheet in this embodiment and cutting of a non-strengthened glass sheet basically differ in point of a cutting mechanism between the two, and therefore a crack propagation mode quite differs between the two.

In cutting of the non-strengthened glass sheet, the glass sheet is locally heated with a laser beam while at the same time the laser beam irradiation position on the glass sheet is moved to provide a temperature gradient in the travel direction. A tensile stress is generated on around a rear side of the laser beam irradiation position, and in this case, the crack is propagated by the tensile stress. A front edge position of the crack follows the laser beam irradiation position along with the movement of the laser light irradiation position. In that manner, a crack propagation is attained only by the irradiation energy of the laser beam. Accordingly, when the laser irradiation is stopped in the process of cutting, then crack propagation stops.

As opposed to this, cutting of the physically-strengthened glass sheet in this embodiment utilizes the residual tensile stress originally existing inside the glass sheet, and therefore does not require a tensile stress to be generated by a laser beam, differing from the case of cutting non-strengthened glass sheet. In addition, in this embodiment, when the crack is formed by applying any force to the physically-strengthened glass sheet, then the crack can propagate by itself owing to the residual tensile stress in the sheet. Further, the residual tensile stress inside the glass sheet is present in the entire glass sheet, and therefore the crack can propagate in any direction. Moreover, when a crack propagation speed reaches to some extent, then the crack may branch.

According to a knowledge that the present inventors have obtained, when the internal residual tensile stress (CT) of the intermediate layer 17 reaches 30 MPa or more, then the crack formed in the physically-strengthened glass sheet 10 naturally propagates (runs by itself) only by the residual tensile stress of the intermediate layer 17.

Consequently, in this embodiment, while the physically-strengthened glass sheet 10 is cut by propagating the crack 30 due to the internal residual tensile stress CT, the intermediate layer 17 is locally heated at a temperature not higher than the annealing point thereof by the laser beam 20 to thereby locally generate the tensile stress smaller than the internal residual tensile stress CT or a compressive stress in the intermediate layer 17 to prevent the propagation of the crack 30 due to the internal residual tensile stress CT. Specifically, by controlling the moving speed of the irradiation position of the laser beam 20, the crack propagation speed of the crack 30 can be controlled. By controlling the propagation speed of the crack 30, the direction in which the crack 30 propagates can be determined, and the crack 30 can be prevented from branching. In other words, by controlling the propagation speed of the crack, the propagation orbit of the crack 30 can be controlled with high accuracy. Heating the intermediate layer 17 at the temperature not higher than the annealing point is because, when the layer is heated at a temperature higher than the annealing point, then the stress would be relaxed by a viscous flow of the glass sheet.

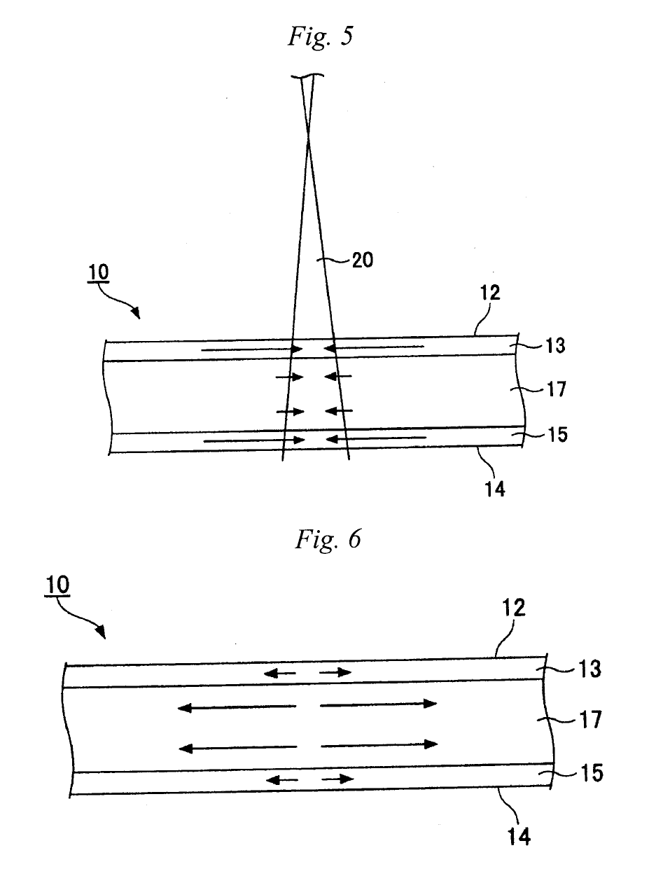

FIG. 5 is a schematic view showing one example of a stress distribution on a cross section cut along the A-A line in FIG. 4. FIG. 6 is a schematic view showing one example of a stress distribution on a cross section cut along the B-B line in FIG. 4. The cross section of FIG. 6 is behind the cross section of FIG. 5. Here, “behind” refers to a rear part in the travel direction of the laser beam irradiation position in the physically-strengthened glass sheet (that is, a rear part in the crack propagation direction in the physically-strengthened glass sheet). In FIG. 5 and FIG. 6, the arrowed direction indicates the action direction of the stress in the physically-strengthened glass sheet; and the dimension of the arrow indicates the intensity of the stress in the physically-strengthened glass sheet.

As shown in FIG. 5, the laser-irradiated part of the intermediate layer 17 is heated so that such a part of the intermediate layer 17 becomes at a higher temperature than the other part thereof. Consequently, the laser-irradiated part of the intermediate layer 17 is given a tensile stress smaller than the internal residual tensile stress CT or a compressive stress generated therein, and the propagation of the crack 30 due to the internal residual tensile stress CT may be thereby prevented. As shown in FIG. 5, when the compressive stress is generated, then the propagation of the crack 30 can be surely prevented. On the other hand, when a tensile stress smaller than the internal residual tensile stress is generated, then the front edge position of the crack 30 becomes close to the irradiation position of the laser beam 20 and therefore the front edge position of the crack 30 can be controlled with accuracy.

As opposed to this, as shown in FIG. 6, an area behind the laser-irradiated part of the intermediate layer 17 and therearound has a lower temperature than the laser-irradiated part of the intermediate layer 17. Consequently, a tensile stress larger than the internal residual tensile stress CT is generated in the area behind the laser-irradiated part of the intermediate layer 17 and therearound. The crack 30 is formed in the part where the tensile stress is over a given level, and is concentrated in the part having a large tensile stress. Consequently, the front edge position of the crack 30 does not deviate from the orbit of the irradiation position of the laser beam 20.

The front edge position of the crack 30 follows the irradiation position of the laser beam 20 along with the movement of the irradiation position of the laser beam 20, and does not pass the irradiation position of the laser beam 20. As long as the front edge position of the crack 30 does not pass the irradiation position of the laser beam 20, the front edge position of the crack 30 may partly overlap with the irradiation position of the laser beam 20.

As in the above, according to this embodiment, the intermediate layer 17 is locally heated by the laser beam 20 to thereby locally generate a tensile stress smaller than the internal residual tensile stress CT or a compressive stress therein to prevent the propagation of the crack 30 due to the internal residual tensile stress CT. Accordingly, the front edge position of the crack 30 can be controlled with accuracy and the cutting accuracy can be thereby improved.

As shown in FIG. 5, the laser-irradiated part of the strengthened layers 13 and 15 is heated and becomes at a higher temperature than the other part of the strengthened layers 13 and 15. Consequently, in the laser-irradiated part of the strengthened layers 13 and 15, a compressive stress larger than the residual compressive stress shown in FIG. 1 and FIG. 2 is generated and the propagation of the crack 30 can be thereby prevented.

In this embodiment, not only the strengthened layers 13 and 15 but also the intermediate layer 17 are heated with the laser beam 20, and therefore the laser beam 20 used here has a high internal transmittance. When the travel distance of the laser beam 20 from having fallen on the physically-strengthened glass sheet 10 to having gone out of the sheet is represented by M, α×M is preferably 3.0 or less (that is, the internal transmittance of the laser beam is preferably 5% or more).

When α×M is 3.0 or less, then it is possible to prevent most irradiation energy of the laser beam 20 from being absorbed as heat by the surface 12 and therearound of the physically-strengthened glass sheet 10, and therefore it is possible to favorably prevent the occurrence of any steep temperature gradient in the sheet thickness direction. Consequently, the laser-irradiated part of the front surface layer 13 can be prevented from being at an extremely higher temperature than the laser-irradiated part of the intermediate layer 17, and the laser-irradiated part of the intermediate layer 17 can be prevented from given a tensile stress larger than the internal residual tensile stress CT generated therein. Accordingly, the front edge position of the crack 30 can be prevented from passing the irradiation position of the laser beam 20.

α×M is more preferably 0.3 or less (the internal transmittance of the laser beam is 74% or more), even more preferably 0.105 or less (the internal transmittance of the laser beam is 90% or more), still more preferably 0.02 or less (the internal transmittance of the laser beam is 98% or more).

In case where the laser beam 20 falls vertically onto the front surface 12 of the physically-strengthened glass sheet 10, the movement distance M of the laser beam 20 is the same as the thickness t of the physically-strengthened glass sheet 10 (M=t). On the other hand, in case where the laser beam 20 falls obliquely onto the front surface 12 of the physically-strengthened glass sheet 10, the beam refracts according to the Snell's law. When the refraction angle is represented by γ, then the movement distance M of the laser beam 20 is calculated approximately from an expression M=t/cos γ.

In order that the propagation of the crack 30 could be attained mainly by the residual tensile stress in the intermediate layer 17, the internal residual tensile stress CT is preferably 15 MPa or more. With that, the position at which the tensile stress reaches a given level (that is, the front edge position of the crack 30) could be sufficiently close to the irradiation position of the laser beam 20, and the cutting accuracy can be thereby improved. The internal residual tensile stress CT is more preferably 30 MPa or more, even more preferably 40 MPa or more. When the internal residual tensile stress CT is 30 MPa or more, then the crack 30 can be propagated only by the residual tensile stress of the intermediate layer 17, and the front edge position of the crack 30 can be further closer to the irradiation position of the laser beam 20 so that the cutting accuracy can be further improved.

Regarding the source of the laser beam 20, for example, usable here is the laser of near infrared rays (hereinafter simply referred to as “near IR”) having the wavelength of from 800 to 1100 nm. The near IR laser includes, for example, a Yb fiber laser (wavelength: 1000 to 1100 nm), a Yb disc laser (wavelength: 1000 to 1100 nm), an Nd:YAG laser (wavelength: 1064 nm), a high-output semiconductor laser (wavelength: 808 to 980 nm). These near IR lasers are high-power and inexpensive ones, with which α×M is easy to control within a desired range.

In this embodiment, a high-power and inexpensive near IR laser is used as the source of the laser beam 20, but the source of the laser beam may be any one capable of securing a wavelength range of from 250 to 5000 nm. For example, there are further mentioned a UV laser (wavelength: 355 nm), a green laser (wavelength: 532 nm), an Ho:YAG laser (wavelength: 2080 nm), an Er:YAG laser (2940 nm), a laser using a mid-IR parametric oscillator (wavelength: 2600 to 3450 nm), etc. The oscillation mode of the laser beam 20 is not defined. Usable here is any of a CW laser for continuous laser beam oscillation, or a pulse laser for intermittent laser beam oscillation. Not also defined, the intensity distribution of the laser beam 20 may be a Gaussian-type one or a top-hat-type one.

In the case of a near-IR laser at around 1000 nm (800 to 1100 nm), the absorption coefficient α increases with the increase in the content of iron (Fe), the content of cobalt (Co) and the content of copper (Cu) in the physically-strengthened glass sheet 10. In addition, in this case, with the increase in the content of the rare earth element (for example, Yb) in the physically-strengthened glass sheet 10, the absorption coefficient α increases at around an absorption wavelength of the rare earth atom. For controlling the absorption coefficient α, iron is used from the viewpoint of the transparency of glass sheet and the cost thereof; and cobalt, copper and rare earth elements may not be contained substantially in the physically-strengthened glass sheet 10.

The intensity of the laser beam 20 attenuates according to the Lambert-Beer law. Accordingly, the area of the laser beam 20 on the back surface 14 may be smaller than the area of the laser beam 20 on the front surface 12, in order that the laser power density (W/cm²) could be the same or nearly the same between the front surface 12 of the physically-strengthened glass sheet 10 and the back surface 14 thereof, or that is, in order that the temperature could be the same or nearly the same therebetween. In case where the focusing position for the laser beam 20 is on the opposite side to the source of the laser beam relative to the physically-strengthened glass sheet 10, the area of the laser beam 20 on the back surface 14 could be smaller than the area of the laser beam 20 on the front surface 12. In case where the temperature is on the same level between the front surface 12 of the physically-strengthened glass sheet 10 and the back surface 14 thereof, the crack 30 could propagate on the same level both on the front surface 12 of the physically-strengthened glass sheet 10 and the back surface 14 thereof.

The focusing position for the laser beam 20 may be inside the physically-strengthened glass sheet 10, or as shown in FIG. 5, on the source of the laser beam side relative to the physically-strengthened glass sheet 10.

On the back surface 12 of the physically-strengthened glass sheet 10, the laser beam 20 may be formed as a circle having a diameter φ smaller than the thickness t of the physically-strengthened glass sheet 10. When the diameter φ is made to be smaller than the sheet thickness t, then the part to be heated of the physically-strengthened glass sheet 10 may not be too large and a part of a cut surface (especially a cutting start part or a cutting end part) may be prevented from being slightly curved. The diameter φ is, for example, 1 mm or less, preferably 0.5 mm or less.

The shape of the laser beam 20 on the front surface 12 of the physically-strengthened glass sheet 10 may range widely, and for example, may be rectangular, oval, etc.

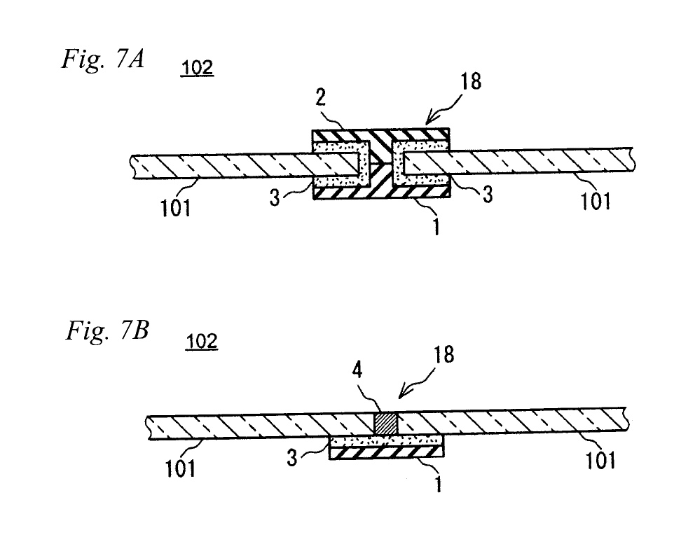

FIGS. 7A and B include cross-sectional views each showing an example of a structure using small-sized sheets according to the assembly step in the first embodiment of the present invention.

In the assembly step, a plurality of small-sized sheets 101 cut out from the large-sized physically-strengthened glass sheet 10 are framed in the frame body 18 to form one structure 102. The frame body 18 is formed of a hard resin or metal frame or a resin/metal composite frame.

The frame body 18 is designed to have a lattice pattern (see (d) of FIG. 8) so that the plurality of small-sized sheets 101 could be framed therein. For example, as shown in FIG. 7A, the frame body 18 comprises at least two members of a base 1 to be a seat and a steadier 2 to fix the small-sized sheet in the frame body 18 by sandwiching it between the two members. Both the base 1 and the steadier 2 are formed in a lattice pattern. The plurality of small-sized sheets 101 are set on the base 1 and fixed thereon by jointing the steadier 2 and the base 1 to thereby fix the small-sized sheets 101 in the frame body 18. In fixing the small-sized sheets 101 in the frame body 18, it is desirable that the sheets are bonded to the frame body with an adhesive 3 or the like from the viewpoint of preventing dropout.

Besides, another mode may be employable here as shown in FIG. 7B, in which the plurality of small-sized sheets 101 are bonded to the base 1 formed in a lattice pattern, via an adhesive 3, then a filler 4 is filled into the space between neighboring small-sized sheets 101 and dried to form the frame body 18. Though not shown, casting may also be employable here, in which a plurality of small-sized sheets are aligned and arranged in a mold and a resin is cast into the mold to integrate the small-sized sheets in a frame.

The frame body 18 is not always required to be in the lattice pattern, but may have any desired configuration in accordance with the shape of the small-sized sheets. The base 1 of the frame body 18 may not have a shape corresponding to the shape of the small-sized sheets 101, but may be formed to be tabular with no opening area. Further, providing light-emitting elements and others in the frame body 18 may improve the design properties of the structure.

The structure 102 produced in the assembly step is formed of a physically-strengthened glass sheet, and therefore, as compared with a structure formed of an already-existing non-strengthened glass sheet, has a high structural strength and satisfies both design performance and light transmittance peculiar to glass sheet, and can be utilized in various scenes as an excellent member. Concrete applications of the structure include, for example, structural materials such as window frames, floor materials, wall materials, etc.; exterior members and structural members of vehicles, etc. Using a colored physically-strengthened glass sheet makes it possible to provide members having further better design properties. Adding a metal to molten glass to be a source material for the glass sheet makes it possible to provide colored structures, for example, structures colored in red, blue, green, etc.

FIG. 8 includes views showing one example of a step of cutting out small-sized sheets 101 from a large-sized physically-strengthened glass sheet 10 to form the structure. (a) of FIG. 8 shows the large-sized physically-strengthened glass sheet 10. First, in the strengthening step, the large-sized glass sheet is subjected to the above-mentioned physically-strengthening treatment to produce the large-sized physically-strengthened glass sheet 10. Next, in the cutting step, the sheet is irradiated with the laser beam 20 along the designed cut line 31 according to the above-mentioned method as shown in (b) of FIG. 8. After these steps, small-sized sheets 101 can be obtained as shown in (c) of FIG. 8. In the case of FIG. 8, the small-sized sheets 101 are rectangular in shape. However, according to this embodiment, the sheets can be cut out in any desired shape of, for example, a hexagon, a circle, etc. Next, in the assembly step, small-sized sheets are framed in the frame body 18 according to the above-mentioned method to form a structure. In the case of (d) of FIG. 8, the small-sized sheets 101 are framed in the lattice-like frame body 18 to form the structure 102.

As in the above, the plurality of small-sized sheets 101 are cut out from the large-sized physically-strengthened glass sheet 10, and therefore, small-sized sheets can be produced from the physically-strengthened glass sheet though the production has heretofore been difficult. In addition, it has become possible to produce the structure using small-sized sheets. Preferably, the small-sized sheet 101 has a circumscribed circle diameter of 100 mm or less. It is difficult to convey small-sized glass sheets having a circumscribed circle diameter of 100 mm or less, using conveyor rollers, and therefore, the first embodiment of the present invention is effectively applied to such small-sized glass sheets. More preferably, the small-sized sheet 101 has the circumscribed circle diameter of 80 mm or less, even more preferably 50 mm or less.

### Second Embodiment

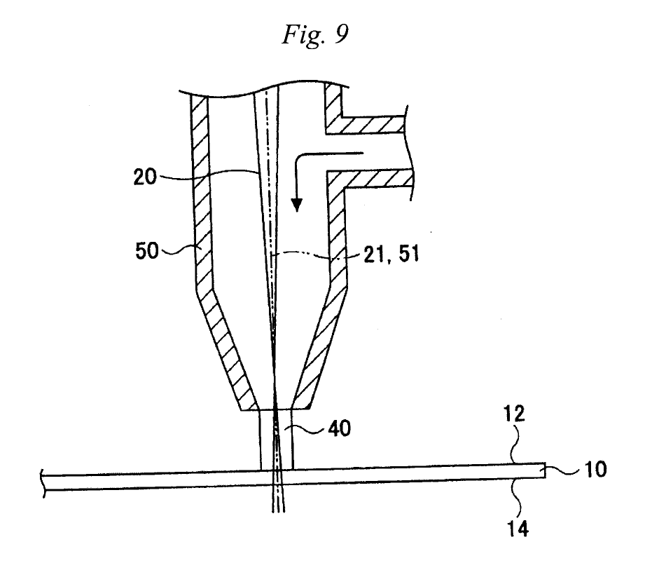

FIG. 9 is an explanatory view of a cutting step according to the second embodiment of the present invention. In FIG. 9, the same reference sign as in FIG. 3 is given to the same constitution to omit further description thereof.

The cutting step in this embodiment includes a step of spraying a gas 40 to the large-sized physically-strengthened glass sheet 10, and the position at which the gas 40 is sprayed to the physically-strengthened glass sheet 10 is moved in conjunction with the irradiation position of the laser beam 20 to cut the physically-strengthened glass sheet 10. As shown in FIG. 9, the irradiation position of the laser beam 20 may be inside the spraying position of the gas 40. The spraying position of the gas 40 may be before or behind the irradiation position of the laser beam 20. The gas sprays off the substance (for example, dust) adhering to the physically-strengthened glass sheet 10 to thereby prevent the laser beam 20 from being absorbed by the adhered substance and prevent the front surface 12 of the physically-strengthened glass sheet 10 from being overheated.

The gas 40 may be a cooling gas (for example, compressed air at room temperature) capable of locally cooling the physically-strengthened glass sheet 10. A steep temperature gradient is provided along the travel direction of the irradiation position of the laser beam 20, and therefore, the distance between the position at which the tensile stress reaches a given level (that is, the front edge position of the crack 30) and the position of the laser beam 20 is thereby shortened. Consequently, the position control performance of the crack 30 is increased, and the cutting accuracy can be thereby further improved.

The nozzle 50 is formed, for example, like a cylinder as in FIG. 9, and the laser beam 20 may run through the inside of the nozzle 50. A central axis 51 of the nozzle 50 and an optical axis 21 of the laser beam 20 may be arranged concentrically. A positional relationship between the spraying position of the gas 40 and the irradiation position of the laser beam 20 can be stabilized.

For moving the spraying position of the gas 40 on the physically-strengthened glass sheet 10, the physically-strengthened glass sheet 10 may be moved, or the nozzle 50 may be moved, or both the two may be moved.

The first and second embodiments of the cutting method of cutting out small-sized sheets from the large-sized physically-strengthened glass sheet and the structure, and also the method for manufacturing the structure have been described in the above; however, the present invention is not limited to the above-mentioned embodiments, and various modifications and changes may be applied thereto.

The present application is based on Japanese Patent Application No. 2012-155565 filed on Jul. 11, 2012, the contents of which are incorporated herein by reference.

### DESCRIPTION OF REFERENCE NUMERALS AND SIGNS

10 PHYSICALLY-STRENGTHENED GLASS SHEET
12 FRONT SURFACE
13 FRONT SURFACE LAYER (STRENGTHENED LAYER)
14 BACK SURFACE
15 BACK SURFACE LAYER (STRENGTHENED LAYER)
17 INTERMEDIATE LAYER
18 FRAME BODY
20 LASER BEAM
30 CRACK
40 GAS
101 SMALL-SIZED SHEET

1. A method for manufacturing a small-sized sheet, the method comprising:
a strengthening step of physically strengthening a glass sheet by quenching a heated glass sheet with bringing a front surface and a back surface of the heated glass sheet into contact with a coolant, thereby producing a physically-strengthened glass sheet which has a front surface layer and a back surface layer as strengthened layers having a residual compressive stress, and an intermediate layer having an internal residual tensile stress and is formed between the front surface layer and the back surface layer; and
a cutting step of cutting out the small-sized sheet from the physically-strengthened glass sheet by locally irradiating the physically-strengthened glass sheet with a laser beam, moving a laser beam irradiation position on the physically-strengthened glass sheet along a designed cut line, and propagating a crack running through the physically-strengthened glass sheet in a sheet thickness direction,
wherein, in the cutting step, the intermediate layer is locally heated with the laser beam at a temperature not higher than an annealing point thereof to thereby locally generate a tensile stress smaller than the internal residual tensile stress or a compressive stress in the intermediate layer to control a propagation speed of the crack due to the internal residual tensile stress.

2. The method for manufacturing the small-sized sheet according to claim 1, wherein, in the cutting step, a plurality of small-sized sheets are cut out from the physically-strengthened glass sheet.

3. The method for manufacturing the small-sized sheet according to claim 1, wherein the small-sized sheet has a circumscribed circle diameter of 100 mm or less.

4. The method for manufacturing the small-sized sheet according to claim 1, wherein the physically-strengthened glass sheet is a colored glass sheet.

5. The method for manufacturing the small-sized sheet according to claim 1, wherein the laser beam has a wavelength of from 250 to 5000 nm.

6. The method for manufacturing the small-sized sheet according to claim 1, wherein the internal residual tensile stress of the intermediate layer is 15 MPa or more.

7. The method for manufacturing the small-sized sheet according to claim 6, wherein the internal residual tensile stress of the intermediate layer is 30 MPa or more.

8. The method for manufacturing the small-sized sheet according to claim 1, wherein the cutting step includes a step of locally spraying a gas to the physically-strengthened glass sheet, and a gas spraying position on the physically-strengthened glass sheet is moved in conjunction with the laser beam irradiation position.

9. The method for manufacturing the small-sized sheet according to claim 8, wherein the gas is a cooling gas for cooling the physically-strengthened glass sheet heated by the laser beam.

10. A method for manufacturing a structure, the method comprising an assembly step of framing a plurality of the small-sized sheets obtained by the method for manufacturing the small-sized sheet according to claim 1 into a frame body to thereby assemble one structure from the plurality of the small-sized sheets.

11. A structure comprising:
a plurality of small-sized sheets cut out from a physically-strengthened glass sheet which has a front surface layer and a back surface layer as strengthened layers having a residual compressive stress, and an intermediate layer having an internal residual tensile stress and is formed between the front surface layer and the back surface layer; and
a frame body so formed as to be able to frame the small-sized sheets therein,
wherein the plurality of small-sized sheets are framed and fixed in the frame body.
